(19) United States
(12) Patent Application Publication
(10) Pub. No.: US 2002/0191590 A1
(43) Pub. Date: Dec. 19, 2002

(54) Scalable open-architecture telecommunications network for voice and data

(75) Inventors: Lijun Niu, Fairfax, VA (US); Holger C. Dietze, Fairfax, VA (US); Huey-Er Hwang, Fairfax, VA (US); Trevor M. Dearman, Fairfax, VA (US)

Correspondence Address: GREENBERG-TRAURIG, 1750 TYSONS BOULEVARD, 12TH FLOOR, MCLEAN, VA, 22102, US

(73) Assignee: Denwa Communications, Inc., Fairfax, VA

(21) Appl. No.: 10/144,773

(22) Filed: May 15, 2002

Related U.S. Application Data
(60) Provisional application No. 60/290,666, filed on May 15, 2001.

(51) Int. Cl. H04L 12/66

(52) U.S. Cl. 370/352

(57) ABSTRACT

Disclosed is a novel telecommunications network architecture employing an application layer, a call control layer and a transport layer composed of seamlessly integrated Key Network Components. Additional applications such as billing on the Web Portal may be added or modified without affecting the call control layer which may be a Softswitch or Integrated SIP device. The transport or infrastructure layer acts as a media gateway and can be migrated to new platforms without affecting the call control layer or application layer. The network is of an open architecture and various features can be added to the network as required. The network can be distributed with the call control layer separated from the transport layer to provide efficiencies or redundancies within the public communication network. A configurator function automatically installs new devices or services at the request of a customer. A traffic management engine routes called based on quality of service.

This application claims the benefit of U.S. Provisional Patent Application No. 60/290,666 filed May 15, 2001, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

This invention relates to a system and methods for providing telecommunications over the Internet, and more particularly to a system architecture for providing intelligent call processing, enabling features that circuit switch networks are not able to provide as well ensuring the quality of service over the managed IP network.

### BACKGROUND OF THE INVENTION

Among the many trends in telecommunications, increasing Internet traffic is probably the most obvious. Currently growing at roughly 10 percent per month according to most estimates, Internet traffic is projected to double every 3-6 months, and will continue to do so for at least the next decade. Behind this explosive growth are the millions of new users, richer content like multi-media, and the migration of corporate voice and data traffic onto the Internet. Today, escalating Internet traffic demands are pushing beyond the limits of today's switching architectures, forcing carriers to rethink their network strategies. Forrester Research estimates that more than 50 percent of current voice traffic will be carried on new IP networks within a decade. An entirely new generation of highly scalable switching technology is necessary to meet the requirements of today's network users. In addition, digitized information can be combined not only with other voice conversations, but it can be then merged with other formats such as facsimile, video and Internet traffic. Convergence implies that the collective conglomeration of media formats and sources is more efficiently transported on a single network rather than individual special use networks. The physical work and right a way access rights required to lay fiber creates an economy of scale such that digging one trench is easier than several parallel trenches.

What is needed is a telecommunications network capable of transporting all communication and media having large economic efficiencies. To the consumer on the Internet, access to the web has brought a world of information choices to their desktop. New technologies such as Session Initiation Protocol (SIP) can be used to initiate, manage and terminate interactive sessions, including voice conversations, over a public network. What is needed is a system to provide full service telecommunications having high level of quality and ease of use.

### SUMMARY OF THE INVENTION

The invention provides the infrastructure for a new generation of telephony—a highly reliable, massively scalable IP-centric converged voice/data architecture consisting of a hybrid of services and reliability from traditional telephony and IP transport and multi-media applications. The communication network is feature rich, providing powerful new tools to the end user which were previously unavailable due to the constraints of the circuit-switched environment. The present invention is a value-added services framework which can deliver enhanced telecommunications capabilities to the market as services, not as boxes and wires that must be integrated at the user end. This system will power the network service providers with a scalable, flexible, enhanced-service architecture, IP-centric solution to compete for subscribers and gain a competitive advantage over traditional network providers.

The core network fabric and call control and metering devices are the basis for the initial phase of the product rollout. Concurrent with the introduction of the new technology, it has been understood the importance of integrating with legacy technology. This system is also designed to deliver combinations of media sources to the consumer in much the same way as they understand them today while at the same time employing transport technologies that offer improved efficiency and convenience at a reduced cost and superior quality in the existing network. The customer will be able to choose the quality of service desired and pay for only the quality level chosen.

The invention in its preferred embodiments includes a novel telecommunications network architecture employing an application layer, a call control layer and a transport layer composed of seamlessly integrated Key Network Components. Additional applications such as billing on the Web Portal may be added or modified without affecting the call control layer which may be a Softswitch or Integrated SIP device. The transport or infrastructure layer acts a media gateway and can be migrated to new platforms without affecting the call control layer or application layer of the present public communications network. The network is of an open architecture and various features can be added to the network as required. The network can be distributed with the call control layer separated from the transport layer to provide efficiencies or redundancies within the public communication network. A configurator function automatically installs new devices or services at the request of a customer. A traffic management engine routes called based on quality of service. This invention provides a cost-effective, reliable, scalable, open-architecture, network architecture.

### BRIEF DESCRIPTION OF THE DRAWINGS

FIG. 1 is a high level illustration of the system architecture.

FIG. 2 is an illustration of the New Public Communication Network key elements.

FIG. 3 is an illustration of the wholesale model for the present system.

FIG. 4 is an illustration of the retail model for the present system.

FIGS. 5a and 5b show the web portal feature of the present invention.

FIGS. 6a and 6b show the configurator feature of the present invention.

FIGS. 7a and 7b shows the traffic management engine feature of the present invention.

### DETAILED DESCRIPTION OF THE PREFERRED EMBODIMENT

Telecommunication carrier owners are understandably reluctant to discard billions of dollars of legacy equipment yet realize that the Public System Telephone Network (PSTN) will need to evolve into something completely different to handle the demands of today's users. Because the volume of telecommunications traffic is predominantly data, it is no longer sensible to create and maintain two parallel networks, one for voice and a second one for data. Voice and data networks are converging. Most carriers agree that the equipment using either Asynchronous Transfer Mode (ATM) or Internet Protocol (IP) is much less costly and more efficient than circuit switching. Distributive software paired with a packet-based architecture can now achieve the same functionality as a Class 5 telecommunications switch. Industry players are realizing that the “Softswitch” is the answer to transforming PSTN networks into a more flexible, scalable solution that can accommodate the increasing data traffic and provide the carriers with the ability to generate revenue through value-added services. Consequently, Softswitch architectures are emerging as the next-generation solution to converged voice and data networks.

The New Public Communication Network must be of a superior quality. This is particularly important in the case of voice over the Internet. While the flexibility and low cost associated with Internet telephony has driven rapid market entry, other factors have limited full deployment and acceptability of the technology as a substitute for conventional use of the telephone network. Because there is not a single builder of the Internet infrastructure, the network is simply smaller networks linked together, and the reliability of the throughput of the data over the Internet or to provide a predictable quality of service level for time sensitive applications across an IP infrastructure is not guaranteed. A voice over IP telephone call session often ends with poor results. For example, if the voice converted to data transits within the Internet for an extended period of time, the latency results in jumbled or choppy voice communication. The model of a free voice over the Internet is flawed from the perspective that reliability cannot be built into a system that is inherently unreliable or uncontrollable.

Today's call model is very different from in the past. Today's model is a trend towards “always on” or “persistent” connection. The new equipment designed to handle the persistent connection is generically referred to as a Softswitch. Softswitch allows telephony that is highly reliable, massively scalable IP-centric with a converged voice/data architecture consisting of a hybrid of services and reliability from traditional telephony and IP transport and multi-media applications.

There are four principle goals in designing the infrastructure for its part of the New Public Communication Network. The network must be cost effective, must support quality of service through reliability, must be scalable, and finally must have an open architecture that allows adoption of new protocols and applications.

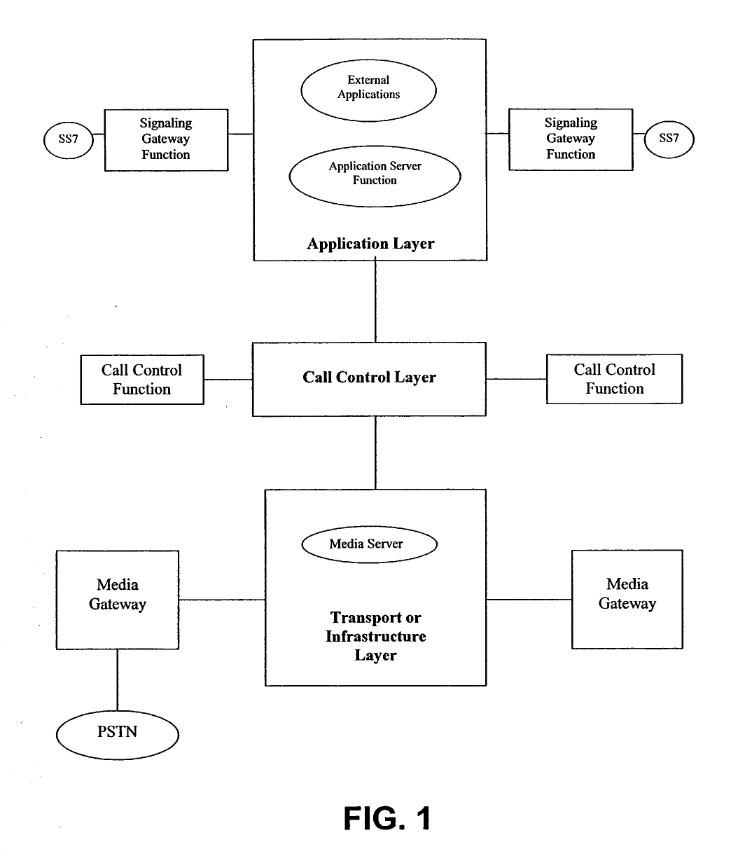

In FIG. 1 is disclosed a high-level view of the New Public Communications Network architecture comprising three main layers.

The application layer is comprised of Application Server that deliver Class 5 features, new services and applications such as video and wireless. The Application Layer is a key component that provides the software-defined gateway features and services. The Application Layer is designed to integrate other enhanced services such as unified messaging, PDA support, PC user tools in addition to other features such as call-waiting and call-forwarding. The Application Server is such that new applications can be added or removed from the system without impacting the other two major components of the network architecture.

The second layer, the Call Control Layer or “Softswitch” layer, delivers the Call Agent such as session initiation setup and teardown and signaling such as SS7 standards.

The third layer, Transport or Infrastructure Layer provides device components such as Media and Trunking Gateways, DSLAMSs, IADs, and other next generation switches.

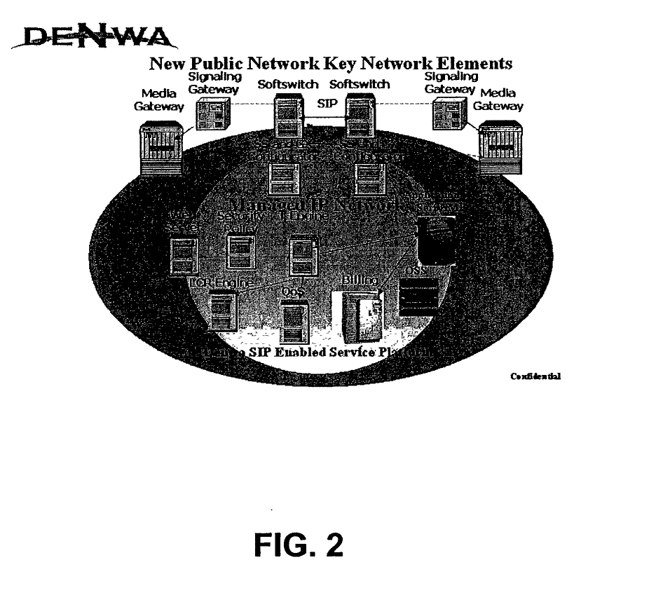

Shown in FIG. 2 is the overall New Public Communications Network which comprises seven key components. The media gateways and integrated access devices are implemented at the network edge to translate and coordinate the delivery of media to and from the public network. Essentially, these are the black boxes that are located either in a central office or the customer premise to allow access to the public network. Operation of the media gateway is controlled by the Softswitch.

The Softswitch manages the flow of traffic on the network. This includes call routing, translations and call logic. Further, the Softswitch enables interoperability between media gateways, networks and protocols. In addition, the Softswitch works with other key network products to optimize overall utilization.

The Application Server, provides software defined features and services. This includes the traditional Class 4 or Class 5 features to which consumers are accustomed, but also advanced features which are characteristic of next generation networks. Examples of Class 5 features are call-waiting and call-forwarding and may include selected other features such as conference-calling. The Application Server is designed such that new applications can be added to the network without changing the Call Control Layer or the Transport Infrastructure Layer.

The Traffic Management Engine provides dynamic routing information to the Application Server. Based on the network resources available, the Traffic Management Engine serves to maximize customer defined preferences and requirements. Real Time Consumer optimization is based on core requirements such as quality of service, least cost routing options, and control of network profiles. These functions are described later in more detail.

The Configurator is a network component that manages the initial setup of a new or unknown elements on a network. When a new or unknown network element such as a Softswitch, media gateway, or Internet access device is introduced, the Configurator will automatically initiate the process of building a default route enabling network paths and establishing the node as an available network resource. This functionality is especially important for each of the three target markets of wholesale, retail and enterprise. It will serve to quickly integrate wholesale carrier networks for traffic exchange, integrate existing corporate commercial private networks, and map out links to Internet access devices employed by the end user. A more detailed discussion of the Configurator is presented later.

The operating support system (OSS) provides network management, provisioning, customer care and billing support. Billing can be done concurrently at the wholesale and retail levels. The OSS allows subscribers to self provision features of the Public Communications Network.

The Web-Enabled Portal provides a comprehensive user-friendly interface to all services, user defined preferences, and account information. The portal provides access to mission critical information such as network performance statistics and traffic management. Industry partners and vendors for the operation and support system can be made through the web portal.

An additional component of the public communication network can be added to the system such as a security policy server to provide network security. Again this can be done without affecting the existing system components under the described network architecture.

The system as shown in FIG. 2 has the benefits of interoperability in two distinct areas. First, the transport protocol extends through the entire digital network, the protocols converted back to analog only after passing thru the edge devices such as, The Media Gateway, IADs or SIP phone. This allows digitized voice to interoperate with various networks and protocols that commonly understand each other. Additionally, their operability allows network elements such as Softwswitchs and Media Gateways to interact with each other by speaking a common language independent of an equipment manufacturer. This feature allows rapid innovation of new and existing carrier networks. This feature allows technology decision makers to effectively remove the limitations associated with closed and proprietary networks. By not having to rely on a single manufacturer for complete network solution, best in class features can be selectively used throughout the Public Communication Network.

Traditionally, carriers made optimization decisions based on traffic price and quality in order to maximize customer satisfaction. These optimization decisions are constrained by the lack of information in a timely manner. The invention allows preemptive quality assessments to be made by both the originating and terminating gateways. In coordination with the T-Engine, the Softswitch will evaluate and compare the results and produce the optimal call route based on the quality. In contrast, quality assistance today can only be made based on individual and labor intensive test calls or post traffic statistics. The Softswitch can make routing decisions based on known costs or termination options. This feature enhances the ability to receive real time rate information and allows the T-engine to make dynamic routing decisions. Online access to current rate information allows both carriers and end users to make informed purchasing decisions. As a next generation carrier with a revenue stream based on traffic arbitrage, the invention offers its customers more pricing and routing options.

A new efficiency to routing decisions can be made as a tradeoff between quality service level and cost of service, the service standards can be implemented into the T-engine to provide a balance of both cost and quality. Carriers will have the ability to provide customer varying service levels depending upon the willingness to pay for the higher quality routes.

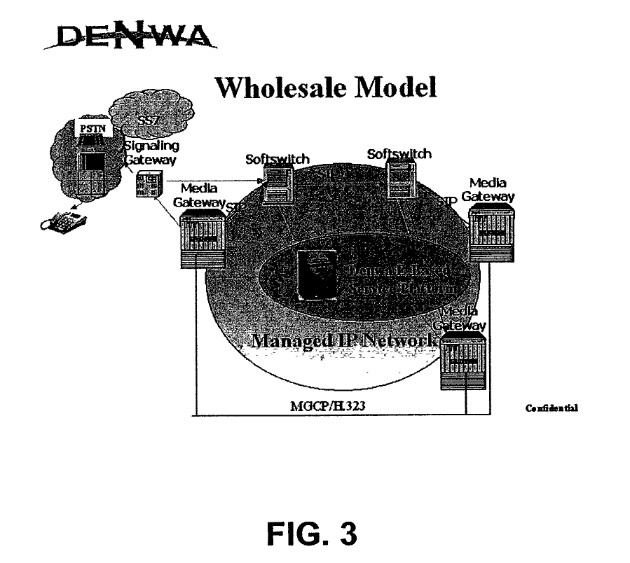

In the wholesale pricing model shown in FIG. 3, a wholesale customer using the SIP enabled network will interconnect with the Public Communication Network as a vendor and a customer. As the wholesale customers have already approved provisions, the customer interface will be geared towards routing the traffic. In other words, the wholesale customer will be able to self route calls to the network's outbound routes purely based on quality and cost.

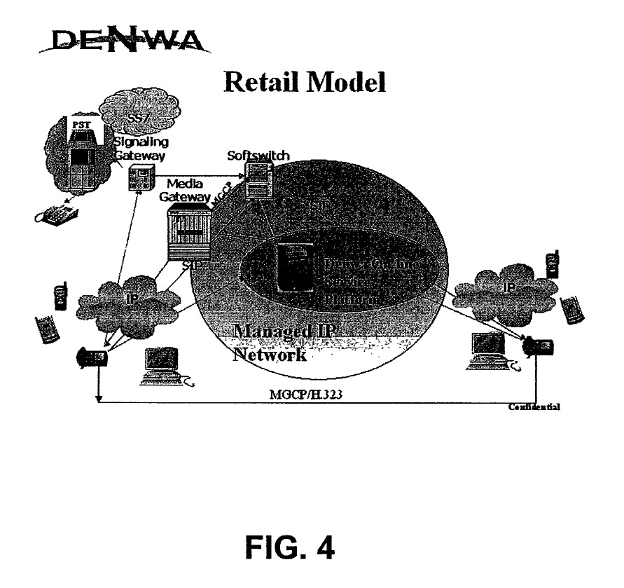

The retail pricing model as shown in FIG. 4 where the retail customer will have the ability to go online and self-provision phone service. In order for the customer to provision service, he would need an SIP enabled phone. An assigment of the phone's address and validating billing parameters will be made and an agreement with supporting carriers will be provided for termination of traffic.

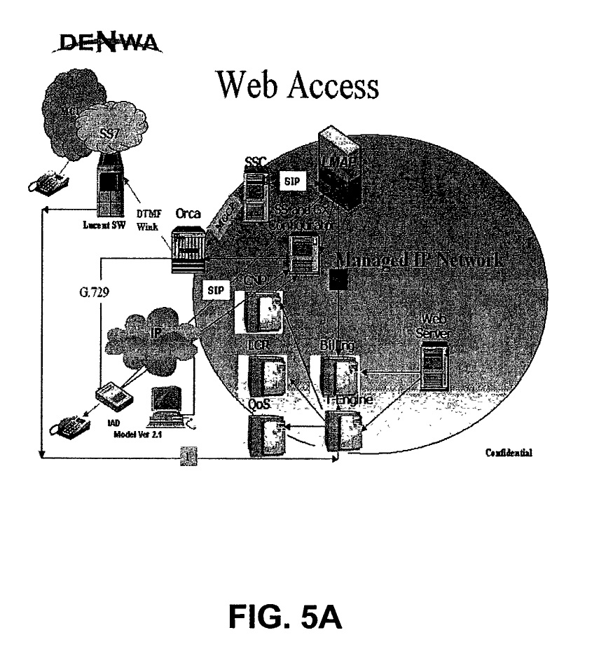

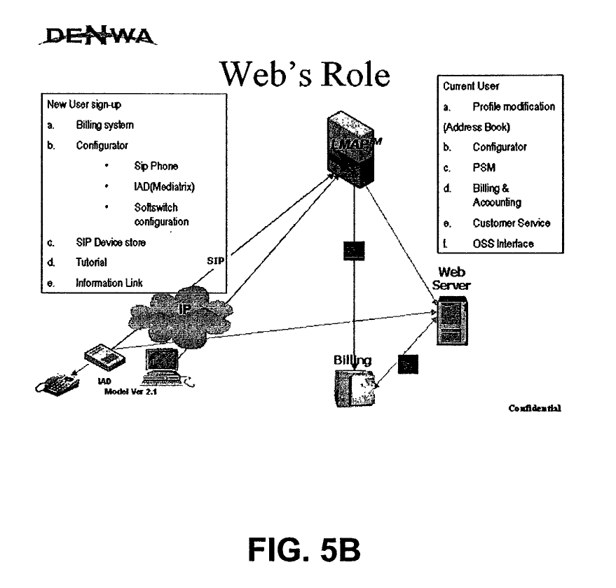

Shown in FIGS. 5a and 5b is the Web Portal. The Web Portal allows the user to access the system, to open a new user account by specifying user name and password, provide general information, provide billing location information, configure the device under a billing location, select features for the device and create account information for the device. For a current user, the customer would log in with an assigned user name and password, modify general and billing information, modify device and account information, add devices, and view call details with billing location and account breakout. The current user can also activate features they desire to their telecommuncations system.

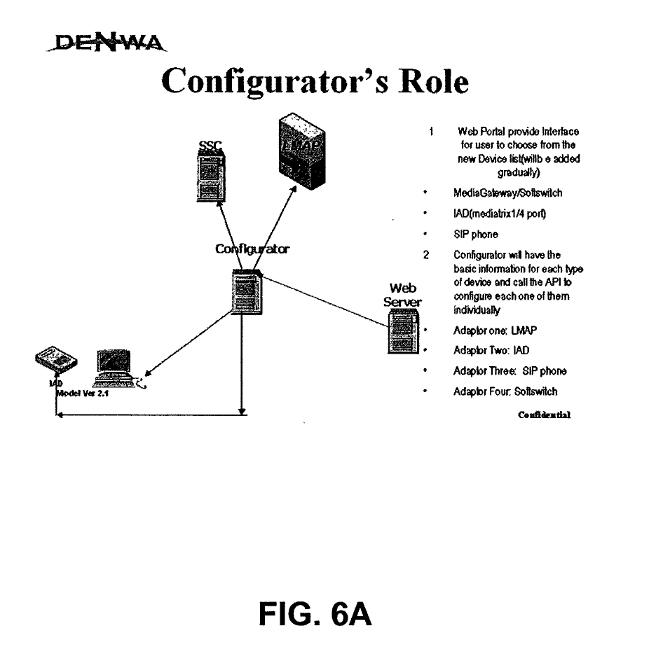

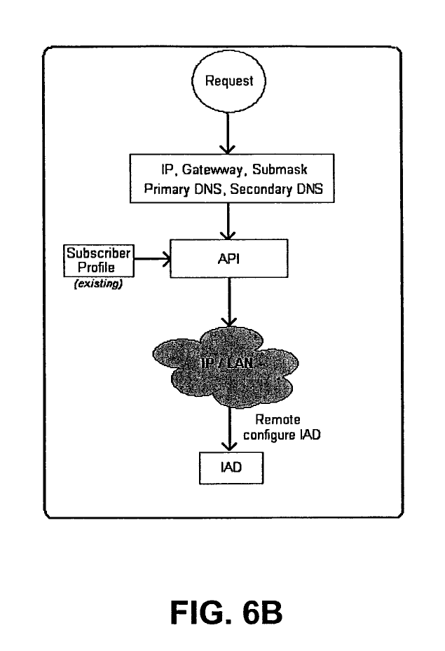

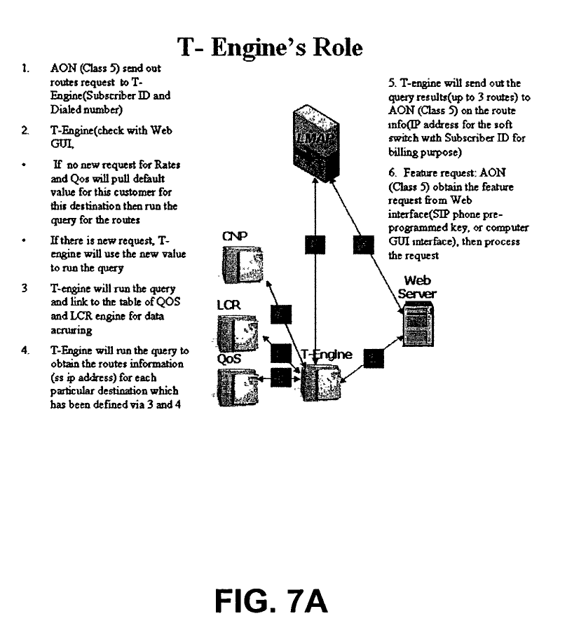

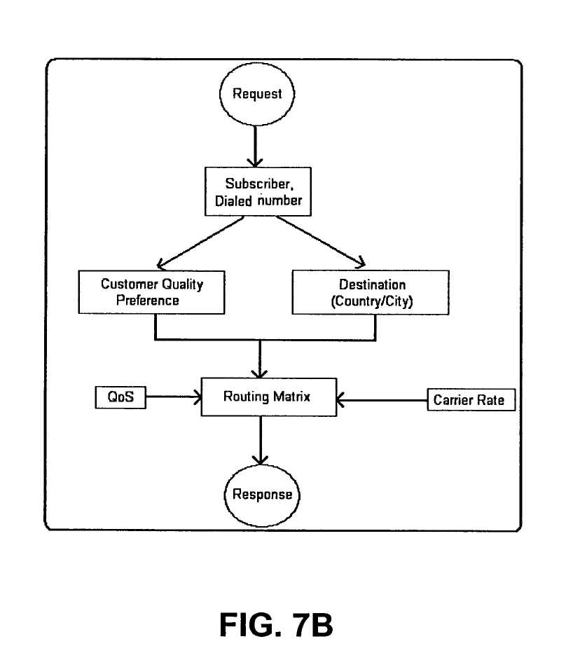

The Configurator is shown in FIGS. 6a and 6b. After accessing the Web Portal, the Configurator will be used to automatically receive a request for service, pass the end users IP address, gateway, submask, primary DNS and secondary DSN to an application programming interface (API) function. Then the configurator will remotely via the local area network (LAN) reconfigure the Internet access device (IAD). For an existing user, when the Configurator receives a request to change the original configuration, it will go to the subscriber profile to get the original information, then it will pass the new and old IP address, gateway, submask, primary DNS and secondary DNS to an API to complete. Based on the configurator instructions, the IAD will be reconfigured.

A traffic management engine provides dynamic routing information to the application server. Based on the network resources available, the Traffic Management Engine (T-Engine) serves to maximize customer defined preferences and requirements. Real time consumer optimization is based on customer requirements such as quality of service, least cost routing, and control network profiles. Upon activation, a Class 5 switch sends a request for service including the subscriber and dials number information to the T-engine. The T-engine checks the country and the city of the number dialed. It also checks the customer/subscriber profile for the destination preference. It then pulls the best route from the routing matrix table which includes carrier rates and quality of service levels. This provides the best match to the customers' requirements and preferences for routing of the call at a given quality of service level.

Appendix A is a series of figures and description showing the architecture of the system in certain embodiments and implementation of procedures for configuring the system and routing telecommunications.

Appendix B consists of selected portions of a business plan to describing the technical configuration of the system and implement the present invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A scalable open-architecture telecommunications network for transporting voice and data, comprising:
an application layer;
a call control layer comprising a softswitch or integrated SIP device; and,
a transport layer comprising integrated key network components for providing a media gateway, said transport layer being separated from said transport layer and being capable of migration to new platforms without affecting said call control layer or said application layer.

2. The open-architecture telecommunications network in accordance with claim 1, further comprising:
configurator means for automatically installing new devices or services at the request of a customer;

3. The open-architecture telecommunications network in accordance with claim 1, further comprising:
traffic management engine for routing calls based on quality of service.
